(19) United States
(12) Patent Application Publication
(10) Pub. No.: US 2025/0178146 A1
(43) Pub. Date: Jun. 5, 2025

(54) MACHINING TOOL THERMAL COMPENSATION SYSTEM BASED ON AN AGGREGATION MODEL AND METHOD THEREOF

(71) Applicant: National Chung Cheng University, Chia-yi County (TW)

(72) Inventors: CHIH-CHUN CHENG, Tainan City (TW); Wei-Jen CHEN, Chiayi City (TW); Yu-Hsin KUO, Taichung City (TW)

(21) Appl. No.: 18/599,578

(22) Filed: Mar. 8, 2024

(30) Foreign Application Priority Data
Dec. 5, 2023 (TW) 112147197

(51) Int. Cl. B23Q 15/18; G05B 19/4065

(52) U.S. Cl. CPC B23Q 15/18; G05B 19/4065; G05B 2219/49206

(57) ABSTRACT

A machining tool thermal compensation system based on an aggregation model includes a calculating module and a processing module. The calculating module executes a first thermal compensation model and a second thermal compensation model. The first thermal compensation model is only related to motor temperature change and the second thermal compensation model is only related to environmental temperature change. The processing module executes an aggregation model based on Kalman filter. The calculating module inputs the motor temperature of a target machining tool at a time point into the first thermal compensation model to generate a first compensation value and inputs the environmental temperature of the target machining tool at this time point into the second thermal compensation model to generate a second compensation value. The processing module executes the aggregation model according to the two compensation values to generate a modified compensation value of this time point.

### CROSS REFERENCE TO RELATED APPLICATION

All related applications are incorporated by reference. The present application is based on, and claims priority from, Taiwan Application Serial Number 112147197, filed on Dec. 5, 2023, the disclosure of which is hereby incorporated by reference herein in its entirety.

### TECHNICAL FIELD

The technical field relates to a thermal compensation system, in particular to a machine tool thermal compensation system based on an aggregation model. The technical field further relates to the thermal compensation method of the system.

### BACKGROUND

The thermal displacement of machining tools (such as lathes, drill machines, milling machines, grinding machines, gear processing machines, and various other currently available machine tools) is one of the major reasons causing machining errors. Generally, the main factors affecting the thermal displacement of machining tools include motor temperature and ambient temperature. Currently available thermal compensation models are usually established by setting different operating conditions under stable ambient temperature. However, since most working environments cannot always maintain a constant temperature, the currently available thermal compensation models are prone to poor compensation effectiveness due to the influence of ambient temperature. Collecting a large amount of experiment data at different ambient temperatures can effectively enhance the robustness of the thermal compensation models, but will simultaneously incurs significant time and labor costs.

### SUMMARY

One embodiment of the disclosure provides a machining tool thermal compensation system based on an aggregation model, which includes a calculating module and a processing module. The calculating module executes a first thermal compensation model and a second thermal compensation model. The first thermal compensation model is only related to in motor temperature change, and the second thermal compensation model is only related to environmental temperature change. The processing module executes an aggregation model based on a Kalman filter. The calculating module inputs the motor temperature of a target machining tool at a time point into the first thermal compensation model to generate a first compensation value, and inputs the environmental temperature of the target machining tool at the time point into the second thermal compensation model to generate a second compensation value. Then, the processing module executes the aggregation model according to the first compensation value and the second compensation value to generate a modified compensation value of the time point.

In one embodiment, the processing module performs the estimation stage of the aggregation model according to the second compensation value and the modified compensation value, at a previous time point, of the aggregation model so as to generate an estimated compensation value. The processing module performs the modification stage of the aggregation model according to the estimated compensation value and the first compensation value in order to generate the modified compensation value of the time point.

In one embodiment, the first compensation model and the second thermal compensation model are established via multiple linear regression, artificial neural network or random forest.

In one embodiment, the first thermal compensation model is established based on a first experiment data, and the second thermal compensation model is established based on a second experiment data. The motor temperature variation range of the first experiment data is greater than the motor temperature variation range of the second experiment data, and the environmental temperature variation range of the second experiment data is greater than the environmental temperature variation range of the first experiment data.

In one embodiment, the aggregation model is established by inputting a third experiment data into the first thermal compensation model and the second thermal compensation model. The aggregation model performing a parameter optimization process for a Kalman filter model according to the outputs of the first thermal compensation model and the second thermal compensation model so as to optimize a first aggregation parameter and a second aggregation parameter of the Kalman filter model, The third experiment data has the characteristics of the first experiment data and the second experiment data.

In one embodiment, the first aggregation parameter is process noise, and the second aggregation parameter is measurement noise.

In one embodiment, the machining tool thermal compensation system further includes a motor temperature measurement module. The motor temperature measurement module measures the motor temperature of the target machining tool at the time point and transmits the motor temperature to the calculating module.

In one embodiment, the machining tool thermal compensation system further includes an environmental temperature measurement module. The environmental temperature measurement module measures the environmental temperature of the target machining tool at the time point and transmits the environmental temperature to the calculating module.

Another embodiment of the disclosure provides a machining tool thermal compensation method based on an aggregation model, which includes the following steps: inputting the motor temperature of a target machining tool at a time point into a first thermal compensation model to generate a first compensation value, wherein the first thermal compensation model is only related to motor temperature change; inputting the environmental temperature of the target machining tool at the time point into a second thermal compensation model to generate a second compensation value, wherein the second thermal compensation model is only related to environmental temperature change; and executing an aggregation model based Kalman filter according to the first compensation value and the second compensation value in order to generate a modified compensation value of the time point.

In one embodiment, the step of executing the aggregation model based the Kalman filter according to the first compensation value and the second compensation value in order to generate a modified compensation value of the time point further includes the following steps: performing the estimation stage of the aggregation model according to the second compensation value and the modified compensation value, at the previous time point, of the aggregation model so as to generate an estimated compensation value; and performing the modification stage of the aggregation model according to the estimated compensation value and the first compensation value in order to generate the modified compensation value of the time point.

In one embodiment, machining tool thermal compensation method further includes the following steps: establishing the first thermal compensation model according to a first experiment data; and establishing the second thermal compensation model according to a second experiment data. The motor temperature variation range of the first experiment data is greater than that of the second experiment data, and the environmental temperature variation range of the second experiment data is greater than that of the first experiment data.

In one embodiment, the machining tool thermal compensation method further includes the following steps: inputting a third experiment data into the first thermal compensation model and the second thermal compensation model, wherein the third experiment data has the characteristics of the first experiment data and the second experiment data; and performing a parameter optimization process according to the outputs of the first thermal compensation model and the second thermal compensation model so as to optimize the first aggregation parameter and the second aggregation parameter of a Kalman filter model so as to establish the aggregation model.

In one embodiment, the first aggregation parameter is process noise, and the second aggregation parameter is measurement noise.

In one embodiment, the step of inputting the motor temperature of the target machining tool at the time point into the first thermal compensation model to generate the first compensation value further includes the following step: measuring the motor temperature of the target machining tool at the time point via a motor temperature measurement module.

In one embodiment, the step of inputting the environmental temperature of the target machining tool at the time point into the second thermal compensation model to generate the second compensation value further includes the following step: measuring the environmental temperature of the target machining tool at the time point via an environmental temperature measurement module.

As described above, the machining tool thermal compensation system and the method thereof according to the embodiments of the disclosure may include the following advantages:

(1) In one embodiment of the disclosure, the machining tool thermal compensation system includes a calculating module and a processing module. The calculating module executes a first thermal compensation model and a second thermal compensation model. The first thermal compensation model is only related to in motor temperature change, and the second thermal compensation model is only related to environmental temperature change. The processing module executes an aggregation model based on a Kalman filter. The calculating module inputs the motor temperature of a target machining tool at a time point into the first thermal compensation model to generate a first compensation value, and inputs the environmental temperature of the target machining tool at the time point into the second thermal compensation model to generate a second compensation value. Then, the processing module executes the aggregation model according to the first compensation value and the second compensation value to generate a modified compensation value of the time point. The above machining tool thermal compensation mechanism based on the aggregation model can effectively combine the compensation values of the first thermal compensation model with those of the second thermal compensation model with a view to obtaining optimized modified compensation values. Consequently, the machining tool thermal compensation system can simultaneously take the influences of motor temperature and environmental temperature into consideration in order to appropriately adjusting the compensation values of the two thermal compensation models. In this way, the modified compensation values can be more closely approximate the actual thermal displacement. As a result, the compensation effectiveness of the machining tool thermal compensation system can be significantly enhanced.

(2) In one embodiment of the disclosure, the machining tool thermal compensation system effectively aggregates the compensation values of the first and second thermal compensation models and appropriately adjusts the compensation values of these two models in order to obtain modified compensation values. These modified compensation values can simultaneously reflect the impact of motor temperature and environmental temperature. Accordingly, the robustness of the machining tool thermal compensation system can be greatly improved so as to satisfy actual requirements.

(3) In one embodiment of the disclosure, the machining tool thermal compensation system can repeatedly execute the aforementioned machining tool thermal compensation mechanism based on the aggregation model so as to obtain the real-time modified compensation values of each time point during a machining process. Therefore, the user can take necessary measures based on these real-time modified compensation values on time in order to make sure that the machining tool can achieve excellent machining precision.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRA WINGS

The disclosure will become more fully understood from the detailed description given herein below and the accompanying drawings which are given by way of illustration only, and thus are not limitative of the disclosure and wherein:

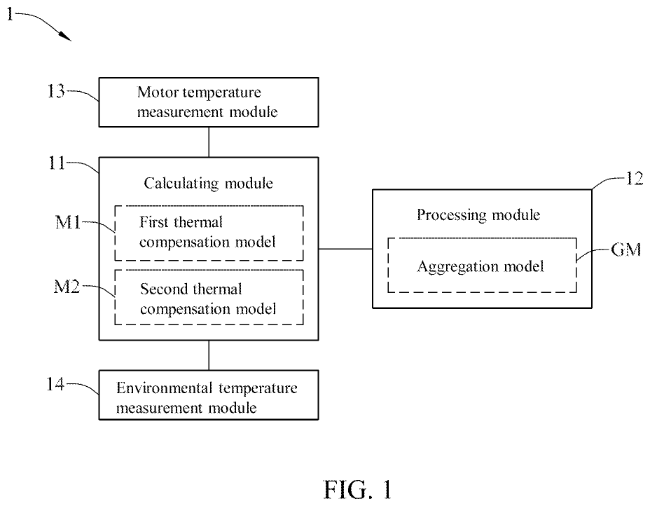

FIG. 1 is a block diagram of a machining tool thermal compensation system based on the aggregation model in accordance with one embodiment of the disclosure.

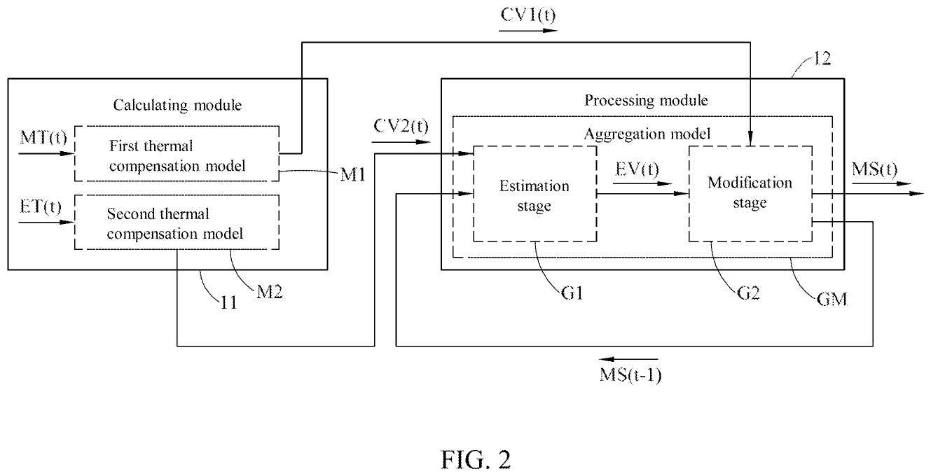

FIG. 2 is a schematic view of an operating mechanism of the machining tool thermal compensation system based on the aggregation model in accordance with one embodiment of the disclosure.

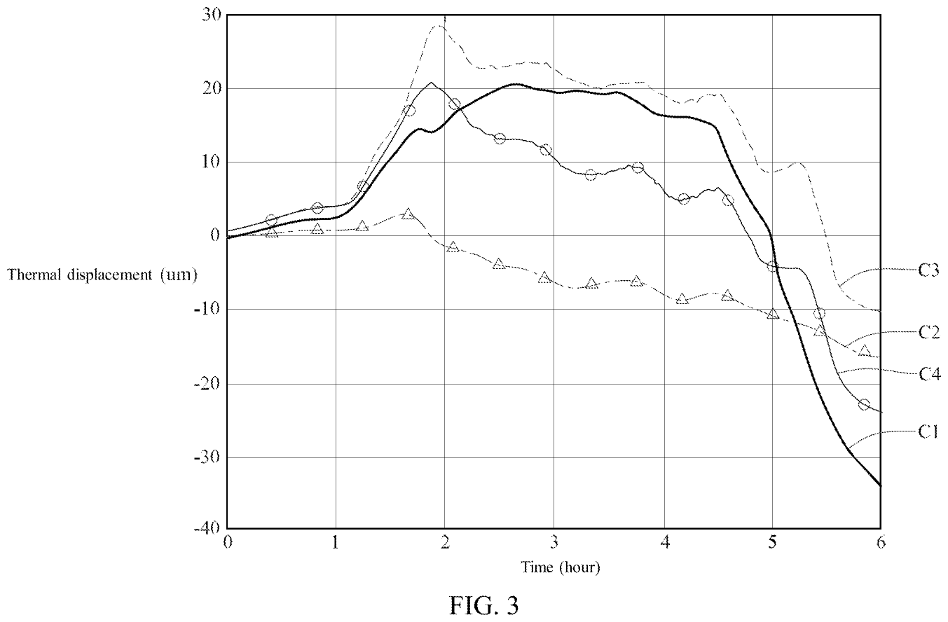

FIG. 3 is a schematic view of a test experiment of the machining tool thermal compensation system based on the aggregation model in accordance with one embodiment of the disclosure.

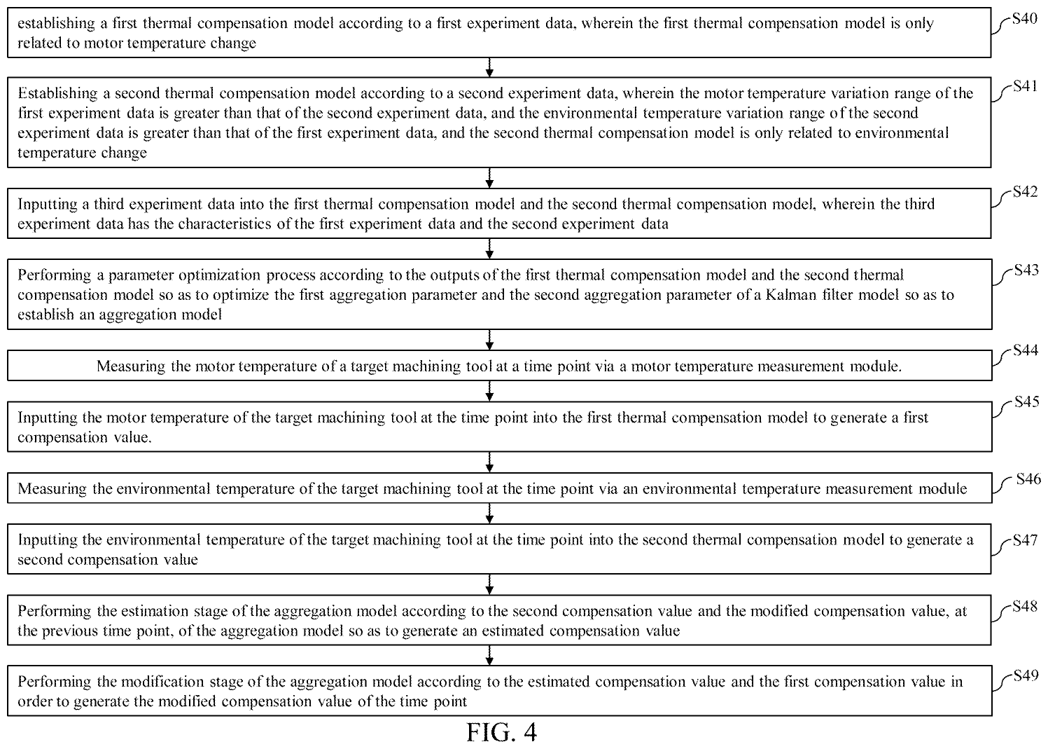

FIG. 4 is a flow chart of a machining tool thermal compensation method based on an aggregation model in accordance with another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Please refer to FIG. 1, which is a block diagram of a machining tool thermal compensation system based on the aggregation model in accordance with one embodiment of the disclosure. As shown in FIG. 1, the machining tool thermal compensation system 1 includes a calculating module 11, a processing module 12, a motor temperature measurement module 13 and an environmental temperature measurement module 14.

The motor temperature measurement module 13 is installed on the target machining tool and measures the motor temperature of the target machining tool. The motor temperature measurement module 13 can be various currently available temperature sensors. The target machining tool can be various machine tools, such as lathes, drilling machines, milling machines, grinding machines, gear processing machines, etc.

The environmental temperature measurement module 14 is disposed on the target machining tool or at a location near the target machining tool so as to measure the environmental temperature of the target machining tool. The environmental temperature measurement module 14 can be various currently available temperature sensors. In another embodiment, the machining tool thermal compensation system 1 may not include hardware devices such as sensors. That is to say, the motor temperature measurement module 13 and the environmental temperature measurement module 14 can be external devices not belonging to the machining tool thermal compensation system 1.

The calculating module 11 is connected to the motor temperature measurement module 13 and the environmental temperature measurement module 14. The calculating module 11 executes the first thermal compensation model M1 and the second thermal compensation model M2. The first thermal compensation model M1 is only related to motor temperature change, while the second thermal compensation model M2 is only related to environmental temperature change. The first thermal compensation model M1 and the second thermal compensation model M2 can be established by multiple linear regression or various artificial intelligence algorithms such as artificial neural network (ANNs), random forest, etc. In one embodiment, the calculating module 11 can be a software module, such as firmware, resident software, microcode, etc. In another embodiment, the calculating module 11 can be a hardware module, such as an application-specific integrated circuit (ASIC), digital signal processor (DSP), digital signal processing device (DSPD), programmable logic device (PLD), field-programmable gate array (FPGA), central-processing unit (CPU), controller, microcontroller unit (MCU), microprocessor, etc. In yet another embodiment, the calculating module 11 may include both hardware and software components simultaneously.

The calculating module 11 inputs the motor temperature measured from the target machining tool at a time point into the first thermal compensation model M1 to generate the first compensation value. Simultaneously, the environmental temperature measured from the target machining tool at the time point is input into the second thermal compensation model M2 to generate the second compensation value. Subsequently, the processing module 12 execute the aggregation model GM according to the first and second compensation values to generate a modified compensation value of the time point.

The first thermal compensation model M1, second thermal compensation model M2 and aggregation model GM can be obtained via a pre-training process. As previously stated, the first thermal compensation model M1 and the second thermal compensation model M2 can be established via multiple linear regression or various artificial intelligence algorithms. Since the first thermal compensation model M1 is only related to motor temperature changes, this model can be established by the manufacturer of the target machining tool. Technicians can set common operating conditions (e.g., the rotational speed of the spindle) for measurement in a constant temperature environment to obtain a first experiment data, so the first experiment can include significant motor temperature change. Based on this data, the first thermal compensation model M1 is established to obtain a universal compensation model capable of adequately reflecting motor temperature change.

As the second thermal compensation model M2 is only related to environmental temperature changes, the user can establish this model by himself/herself. The user can measure data in different seasons to obtain a second experiment data, which includes significant environmental temperature change. In this way, the second thermal compensation model M2 can adequately reflect the environmental temperature change in the user's working environment. Therefore, the motor temperature variation range in the first experiment data is greater than that in the second experiment data, and the environmental temperature variation range in the second experiment data is greater than that in the first experiment data. The provided data can undergo one or more pre-processing procedures, including but not limited to filtering, removing outliers, normalization, smoothing, etc., before being input into the model. These pre-processing procedures are known by those skilled in the art and will not be further described herein.

The aggregation model GM can be established by inputting a third experiment data into the first thermal compensation model M1 and the second thermal compensation model M2 so as to obtain the outputs from both models. The third experiment data has the characteristics of both the first and second experiment data. That is to say, the third experiment data exhibits significant motor temperature and environmental temperature changes simultaneously. Subsequently, a parameter optimization process is performed for the Kalman filter model according to the outputs of the first and second thermal compensation models M1 and M2. The parameter optimization process can optimize the first aggregation parameter Q and the second aggregation parameter R with a view to establishing the aggregation model GM.

In this embodiment, the first aggregation parameter Q is process noise, while the second aggregation parameter R is measurement noise. Additionally, this embodiment uses root-mean-square error (RMSE) and peak value as the objective functions for searching the optimized first aggregation parameter Q and second aggregation parameter R. First, the second aggregation parameter R is fixed at 1, and the first aggregation parameter Q serves as the control variable, defined as Equation (1) given below:

$$0.51 \leq Q ( i ) \leq 1 ; i = 50 ; interval = 0.01 \qquad ( 1 )$$

The optimized first aggregation parameter Q and second aggregation parameter R can be calculated according to Euclidean distance, as shown in Equation (2) given below:

$$d ( i ) = \sqrt{{( R ( i ) - {R}_{a v g} )}^{2} + {( P ( i ) - {P}_{a v g} )}^{2}} \qquad ( 2 )$$

Wherein, d(i) stands for Euclidean distance; R(i) stands for the root mean square error of the thermal displacement error calculated based on the settings of R=1 and Q=Q(i); P(i) stands for the peak value of the thermal displacement error calculated based on the settings of R=1 and Q=Q(i); Ravg stands for the average of all root mean square errors; Pavg stands for the average of all peak values. By calculating the minimum Euclidean distance d(i), the optimal settings for the first aggregation parameter Q and the second aggregation parameter R can be obtained, such that the aggregation model GM can be established.

Please refer to FIG. 2, which is a schematic view of an operating mechanism of the machining tool thermal compensation system based on the aggregation model in accordance with one embodiment of the disclosure. This embodiment exemplifies the operational mechanism of the machining tool thermal compensation system. As shown in FIG. 2, the motor temperature measurement module 13 measures the motor temperature MT(t) of the target machining tool at the time point (t) and transmits the motor temperature MT(t) to the calculating module 11. Similarly, the environmental temperature measurement module 14 measures the environmental temperature ET (t) of the target machining tool at the time point (t) and transmits the environmental temperature ET (t) to the calculating module 11.

Then, the calculating module 11 inputs the motor temperature MT(t) of the target machining tool at the time point (t) into the first thermal compensation model M1 so as to generate the first compensation value CV1(t). Similarly, the calculating module 11 inputs the environmental temperature ET (t) of the target machining tool at the time point (t) into the second thermal compensation model M2 in order to generate the second compensation value CV2(t).

Next, the processing module 12 performs the estimation stage G1 of the aggregation model GM according to the second compensation value CV2(t) and the modified compensation value MS(t−1) of the aggregation model GM at the previous time point (t−1) in order to generate the estimated compensation value EV(t). If the system is running for the first time, the modified compensation value MS(t−1) is 0. Subsequently, the processing module 12, based on the estimated compensation value EV(t) and the first compensation value CV1(t), performs the modification stage G2 of the aggregation model in order to generate the modified compensation value MS(t) at the time point (t). The machining tool thermal compensation system 1 can execute the aforementioned thermal compensation mechanism based on the aggregation model at each time point with a view to effectively aggregate the compensation values of the first thermal compensation model M1 and the second thermal compensation model M2. In this way, the optimized modified compensation value MS(t) can be obtained. From the described operational process, the machining tool thermal compensation mechanism based on the aggregation model can simultaneously consider the effects of motor temperature and environmental temperature in order to appropriately adjust the compensation values of the first thermal compensation model M1 and the second thermal compensation model M2, and produce the modified compensation value MS(t) that is closer to the actual thermal displacement. Therefore, the compensation effect of the system can be enhanced.

The embodiment just exemplifies the disclosure and is not intended to limit the scope of the disclosure. Any equivalent modification and variation according to the spirit of the disclosure is to be also included within the scope of the following claims and their equivalents.

Please refer to FIG. 3, which is a schematic view of a test experiment of the machining tool thermal compensation system based on the aggregation model in accordance with one embodiment of the disclosure. As shown in FIG. 3, the curve C1 stands for the actual thermal displacement. The curve C2 stands for the compensation values of the first thermal compensation model M1. The curve C3 stands for the compensation values of the second thermal compensation model M2. The curve C4 stands for the compensation values of the aggregation model GM.

This embodiment employs a set of test data for simulating the actual processing scenario, as shown in Table 1 given below, which includes complex operating conditions (constant temperature environment, non-constant temperature environment, and different rotational speeds of the spindle):

TABLE 1

| | Settings of | Settings of |
|---|---|---|
| | rotational speed | Air conditioner |
| Time (min) | of spindle (rpm) | (° C.) |
| 92 | 0 | Off |
| 5 | 2500 | |
| 5 | 5000 | |
| 10 | 7500 | |
| 5 | 0 | |
| 40 | 505 | 20 |
| 20 | 1026 | |
| 40 | 625 | |
| 20 | 1224 | |
| 20 | 708 | |
| 10 | 1127 | |
| 10 | | Off |
| 20 | 831 | |
| 10 | 9421 | |
| 50 | | 28 |

The test result shown in FIG. 3 can be obtained by inputting the above the set of test data into the first thermal compensation model M1 and the second thermal compensation model M2 and the aggregation model GM respectively. The RMSE and the peak value of each of the models are shown in Table 2 give below:

| Model | RMSE (um) | Peak value (um) |
|---|---|---|
| First thermal compensation | 17.25 | 25.56 |
| model M1 | | |
| Second thermal | 9.73 | 25.16 |
| compensation model M2 | | |
| Aggregation model GM | 6.93 | 11.37 |

As shown in FIG. 3 and Table 2, the compensation values of the aggregation model GM are closest to the actual thermal displacement and can achieve highest precision.

The embodiment just exemplifies the disclosure and is not intended to limit the scope of the disclosure. Any equivalent modification and variation according to the spirit of the disclosure is to be also included within the scope of the following claims and their equivalents.

Please refer to FIG. 4, which is a flow chart of a machining tool thermal compensation method based on an aggregation model in accordance with another embodiment of the disclosure. As shown in FIG. 4, the machining tool thermal compensation method of the embodiment includes the following steps:

Step S40: establishing a first thermal compensation model according to a first experiment data, wherein the first thermal compensation model is only related to motor temperature change.

Step S41: establishing a second thermal compensation model according to a second experiment data, wherein the motor temperature variation range of the first experiment data is greater than that of the second experiment data, and the environmental temperature variation range of the second experiment data is greater than that of the first experiment data, and the second thermal compensation model is only related to environmental temperature change.

Step S42: inputting a third experiment data into the first thermal compensation model and the second thermal compensation model, wherein the third experiment data has the characteristics of the first experiment data and the second experiment data.

Step S43: performing a parameter optimization process according to the outputs of the first thermal compensation model and the second thermal compensation model so as to optimize the first aggregation parameter and the second aggregation parameter of a Kalman filter model so as to establish an aggregation model.

Step S44: measuring the motor temperature of a target machining tool at a time point via a motor temperature measurement module.

Step S45: inputting the motor temperature of the target machining tool at the time point into the first thermal compensation model to generate a first compensation value.

Step S46: measuring the environmental temperature of the target machining tool at the time point via an environmental temperature measurement module.

Step S47: inputting the environmental temperature of the target machining tool at the time point into the second thermal compensation model to generate a second compensation value.

Step S48: performing the estimation stage of the aggregation model according to the second compensation value and the modified compensation value, at the previous time point, of the aggregation model so as to generate an estimated compensation value.

Step S49: performing the modification stage of the aggregation model according to the estimated compensation value and the first compensation value in order to generate the modified compensation value of the time point.

The embodiment just exemplifies the disclosure and is not intended to limit the scope of the disclosure. Any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer (or a processor). As an example, an embodiment of a computer program product includes a computer useable storage medium to store a computer readable program.

The computer useable or computer readable storage medium can be an electronic, magnetic, optical, electromagnetic, infrared, or semiconductor system (or apparatus or device). Examples of non-transitory computer useable and computer readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, the embodiments of the disclosure (or each module of the system) may be implemented entirely in hardware, entirely in software or in an implementation containing both hardware and software elements. In embodiments which use software, the software may include, but not limited to, firmware, resident software, microcode, etc. In embodiments which use hardware, the hardware may be implemented within one or more application specific integrated circuits (ASICs), digital signal processors (DSPs), digital signal processing devices (DSPDs), programmable logic devices (PLDs), field programmable gate arrays (FPGAs), central-processing unit (CPU), controllers, micro-controllers, microprocessors, electronic devices, other electronic units designed to perform the functions described herein, or a combination thereof.

To sum up, according to one embodiment of the disclosure, the machining tool thermal compensation system includes a calculating module and a processing module. The calculating module executes a first thermal compensation model and a second thermal compensation model. The first thermal compensation model is only related to in motor temperature change, and the second thermal compensation model is only related to environmental temperature change. The processing module executes an aggregation model based on a Kalman filter. The calculating module inputs the motor temperature of a target machining tool at a time point into the first thermal compensation model to generate a first compensation value, and inputs the environmental temperature of the target machining tool at the time point into the second thermal compensation model to generate a second compensation value. Then, the processing module executes the aggregation model according to the first compensation value and the second compensation value to generate a modified compensation value of the time point. The above machining tool thermal compensation mechanism based on the aggregation model can effectively combine the compensation values of the first thermal compensation model with those of the second thermal compensation model with a view to obtaining optimized modified compensation values. Consequently, the machining tool thermal compensation system can simultaneously take the influences of motor temperature and environmental temperature into consideration in order to appropriately adjusting the compensation values of the two thermal compensation models. In this way, the modified compensation values can be more closely approximate the actual thermal displacement. As a result, the compensation effectiveness of the machining tool thermal compensation system can be significantly enhanced.

In addition, according to one embodiment of the disclosure, the machining tool thermal compensation system effectively aggregates the compensation values of the first and second thermal compensation models and appropriately adjusts the compensation values of these two models in order to obtain modified compensation values. These modified compensation values can simultaneously reflect the impact of motor temperature and environmental temperature. Accordingly, the robustness of the machining tool thermal compensation system can be greatly improved so as to satisfy actual requirements.

Moreover, according to one embodiment of the disclosure, the machining tool thermal compensation system can repeatedly execute the aforementioned machining tool thermal compensation mechanism based on the aggregation model so as to obtain the real-time modified compensation values of each time point during a machining process. Therefore, the user can take necessary measures based on these real-time modified compensation values on time in order to make sure that the machining tool can achieve excellent machining precision.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A machining tool thermal compensation system based on an aggregation model, comprising:
a calculating module configured to execute a first thermal compensation model and a second thermal compensation model, wherein the first thermal compensation model is only related to in motor temperature change, and the second thermal compensation model is only related to environmental temperature change; and
a processing module configured to execute an aggregation model based on a Kalman filter;
wherein the calculating module is configured to input a motor temperature of a target machining tool at a time point into the first thermal compensation model to generate a first compensation value, and to input an environmental temperature of the target machining tool at the time point into the second thermal compensation model to generate a second compensation value, and the processing module is configured to execute the aggregation model according to the first compensation value and the second compensation value to generate a modified compensation value of the time point.

2. The machining tool thermal compensation system based on the aggregation model of claim 1, wherein the processing module performs an estimation stage of the aggregation model according to the second compensation value and the modified compensation value, at a previous time point, of the aggregation model so as to generate an estimated compensation value, wherein the processing module performs a modification stage of the aggregation model according to the estimated compensation value and the first compensation value in order to generate the modified compensation value of the time point.

3. The machining tool thermal compensation system based on the aggregation model of claim 1, wherein the first compensation model and the second thermal compensation model are established via multiple linear regression, artificial neural network or random forest.

4. The machining tool thermal compensation system based on the aggregation model of claim 1, wherein the first thermal compensation model is established based on a first experiment data, and the second thermal compensation model is established based on a second experiment data, wherein a motor temperature variation range of the first experiment data is greater than a motor temperature variation range of the second experiment data, and an environmental temperature variation range of the second experiment data is greater than an environmental temperature variation range of the first experiment data.

5. The machining tool thermal compensation system based on the aggregation model of claim 4, wherein the aggregation model is established by inputting a third experiment data into the first thermal compensation model and the second thermal compensation model, and performing a parameter optimization process for a Kalman filter model according to outputs of the first thermal compensation model and the second thermal compensation model so as to optimize a first aggregation parameter and a second aggregation parameter of the Kalman filter model, wherein the third experiment data has characteristics of the first experiment data and the second experiment data.

6. The machining tool thermal compensation system based on the aggregation model of claim 5, wherein the first aggregation parameter is process noise, and the second aggregation parameter is measurement noise.

7. The machining tool thermal compensation system based on the aggregation model of claim 1, further comprising a motor temperature measurement module configured to measure the motor temperature of the target machining tool at the time point and transmit the motor temperature to the calculating module.

8. The machining tool thermal compensation system based on the aggregation model of claim 1, further comprising an environmental temperature measurement module configured to measure the environmental temperature of the target machining tool at the time point and transmit the environmental temperature to the calculating module.

9. A machining tool thermal compensation method based on an aggregation model, comprising:
inputting a motor temperature of a target machining tool at a time point into a first thermal compensation model to generate a first compensation value, wherein the first thermal compensation model is only related to motor temperature change;
inputting an environmental temperature of the target machining tool at the time point into a second thermal compensation model to generate a second compensation value, wherein the second thermal compensation model is only related to environmental temperature change; and
executing an aggregation model based a Kalman filter according to the first compensation value and the second compensation value in order to generate a modified compensation value of the time point.

10. The machining tool thermal compensation method based on the aggregation model of claim 9, wherein a step of executing the aggregation model based the Kalman filter according to the first compensation value and the second compensation value in order to generate a modified compensation value of the time point further comprises:
performing an estimation stage of the aggregation model according to the second compensation value and the modified compensation value, at a previous time point, of the aggregation model so as to generate an estimated compensation value; and
performing a modification stage of the aggregation model according to the estimated compensation value and the first compensation value in order to generate the modified compensation value of the time point.

11. The machining tool thermal compensation method based on the aggregation model of claim 9, further comprising:
establishing the first thermal compensation model according to a first experiment data; and
establishing the second thermal compensation model according to a second experiment data, wherein a motor temperature variation range of the first experiment data is greater than a motor temperature variation range of the second experiment data, and an environmental temperature variation range of the second experiment data is greater than an environmental temperature variation range of the first experiment data.

12. The machining tool thermal compensation method based on the aggregation model of claim 11, further comprising:
inputting a third experiment data into the first thermal compensation model and the second thermal compensation model, wherein the third experiment data has characteristics of the first experiment data and the second experiment data; and
performing a parameter optimization process according to outputs of the first thermal compensation model and the second thermal compensation model so as to optimize the first aggregation parameter and the second aggregation parameter of a Kalman filter model so as to establish the aggregation model.

13. The machining tool thermal compensation method based on the aggregation model of claim 12, wherein the first aggregation parameter is process noise, and the second aggregation parameter is measurement noise.

14. The machining tool thermal compensation method based on the aggregation model of claim 9, wherein a step of inputting the motor temperature of the target machining tool at the time point into the first thermal compensation model to generate the first compensation value further comprises:
measuring the motor temperature of the target machining tool at the time point via a motor temperature measurement module.

15. The machining tool thermal compensation method based on the aggregation model of claim 9, wherein a step of inputting the environmental temperature of the target machining tool at the time point into the second thermal compensation model to generate the second compensation value further comprises:
measuring the environmental temperature of the target machining tool at the time point via an environmental temperature measurement module.
